(19) United States
(12) Patent Application Publication
(10) Pub. No.: US 2008/0077461 A1
(43) Pub. Date: Mar. 27, 2008

(54) METHODS AND SYSTEMS FOR RANKING IN EXPERT REFERRAL

(76) Inventor: Jonathan Glick, New York, NY (US)

Correspondence Address: STRATEGIC PATENTS P.C.., C/O PORTFOLIOIP, P.O. BOX 52050, MINNEAPOLIS, MN, 55402, US

(21) Appl. No.: 11/834,440

(22) Filed: Aug. 6, 2007

Related U.S. Application Data
(63) Continuation-in-part of application No. 11/549,373, filed on Oct. 13, 2006.
(60) Provisional application No. 60/824,425, filed on Sep. 1, 2006.
(60) Provisional application No. 60/726,725, filed on Oct. 14, 2005.

(51) Int. Cl. G06F 17/50

(52) U.S. Cl. 705/7

(57) ABSTRACT

Provided herein are methods and systems for expert referral and ranking. A method may comprise receiving an indicator related to an activity of an individual on behalf of at least one client; calculating a rank based upon the indicator; and associating the rank with the individual, wherein the rank provides a measure of the individual's value to a community of clients and wherein the indicator is based on the extent to which the individual has been engaged repeatedly.

### CROSS-REFERENCE TO RELATED APPLICATIONS

This application claims the benefit of the following commonly owned provisional application, which is incorporated by reference in its entirety: U.S. Prov. App. No. 60/824,425 filed on Sep. 1, 2006.

This application is a continuation-in-part of the following U.S. patent application, which is incorporated by reference in its entirety: U.S. application Ser. No. 11/549,373 filed on Oct. 13, 2006 which claims the benefit of the provisional application U.S. Prov. App. No. 60/726,725 filed on Oct. 14, 2005

### BACKGROUND

1. Field

This invention generally relates to methods and systems of expert collaboration, and specifically relates to management of ranking systems for expert referral and collaboration.

2. Description of the Related Art

Many professionals have formal or informal restrictions on their ability to assume conflicting professional engagements, particularly where the engagement entails some degree of advocacy for a client. The risk of representing adverse interests of a number of clients is compounded in large firms such as law firms, accounting firms, and other professional groups and organizations. The management of actual or potential conflicts is also complicated when specialists are engaged for niche services.

A need exists for improved methods and systems for enabling the collaboration of experts, including methods and systems for ranking those experts.

### SUMMARY

Provided herein are methods and systems for expert referral and ranking. In an aspect of the invention, a method may comprise receiving an indicator related to an activity of an individual on behalf of at least one client; calculating a rank based upon the indicator; and associating the rank with the individual, wherein the rank provides a measure of the individual's value to a community of clients and wherein the indicator is based on the extent to which the individual has been engaged repeatedly. In an embodiment, the indicator may be based on the frequency of repeat engagement. The engagement is by the same user. The engagement may be by multiple, non-correlated users.

In an embodiment, ranking may be adjusted based on an indicator of an inconvenience. The inconvenience may be at least one of a time difference, a non-responsiveness, a location, and a cost.

In an embodiment, the indicator may be based on a frequency of engagement of an individual. Engagement may be by the same user. Engagement may be by multiple, non-correlated users.

In an embodiment, the method may further comprise adjusting the ranking based on an aspect of a speaking engagement. The aspect may be one or more of a size of the audience, publicity associated with the engagement, a web notice, and a number of references.

In an embodiment, the method may further comprise adjusting the ranking based on an aspect of publishing. The aspect may be at least one of publicity, a web notice, and a number of references.

In an embodiment, the method may further comprise adjusting the ranking based on a credential. In an embodiment, the method may further comprise adjusting the ranking based on an aspect of an advisory board membership. The aspect may be at least one of the market cap of company, the market share of the company, and the company's rank in the Fortune 500.

In an embodiment, the indicator may be an indication of a value of an interaction between the individual and a client in the community. The indication may be an implicit indication. In an embodiment, the method may further comprise adjusting the ranking based on a nomination. In an embodiment, calculating may involve the use of a heuristic. In an embodiment, the method may further comprise designating a status to the individual as a function of the rank. The status may depend upon the rank in relation to other ranks that are associated with other individuals. In an embodiment, the method may further comprise highlighting the individual in a communication depending upon the rank. In an embodiment, the method may further comprise identifying the individual to a client depending upon the rank. In an embodiment, the method may further comprise providing a reward to the individual as a function of the rank.

In an embodiment, calculating may involve weighting at least two indicators to determine the ranking. Weighting may involve assigning a score to an indicator. The indicator may be at least one of repeat engagement of an individual by a single user, repeat engagement of an individual by non-correlated users, a frequency of engagement of an individual, a frequency of engagement of an individual by a single user, a frequency of engagement of an individual by non-correlated users, an increasing frequency of engagement of an individual, an increasing frequency of engagement of an individual by a single user, an increasing frequency of engagement of an individual by non-correlated users, a number of non-correlated users engaging an individual, a number of users engaging an individual, a number of repeat users engaging an individual, a number of articles published, a journal where an article is published, a citation to an article, a speaking engagement, a number of speaking engagements, an aspect of a speaking engagement, a conference attendance, an advisory board membership, an aspect of an advisory board membership, a position at a company, an award, a prestige of an award, a number of grants, a value of grants, an educational level, an educational institution attended, a level of education, a credential, a number of previous engagements, a number of previous engagements for an individual client, a number of clients per time period, a number of current engagements, a feedback rating, an amount earned, a demand for an expert, a supply, a referral to the expert network, a screening of projects for suitability and potential conflicts, an abiding by the terms and conditions for experts, a profile update, a participation in events, an availability, a publication rate, a citation rate, a current academic status, a current employment status, and a number of invited lectures.

In an embodiment, the method may further comprise automatically modifying a ranking based on a change in at least one indicator. In an embodiment, an individual may improve their ranking by at least one of updating their professional profile with pertinent information, taking advantage of and being responsive to opportunities for which they are qualified, staying up to date on key issues in their field, providing the best information they can and being as helpful as possible to clients, and by following designated guidelines.

In an embodiment, an individual ranking above a certain threshold qualifies for membership in a qualification group. Membership in a qualification group may be maintained by engaging in a threshold fraction of proposed, non-conflicted engagements per time period. Membership in a qualification group may oblige an individual to exclusivity. An individual may require consent to confirm their qualification. An individual may receive at least one benefit associated with a qualification group. The benefit may be at least one of status and recognition through status flags displayed in a communication; continued eligibility for certain programs and events; unrestricted consultative relationships with clients; invitations to networking events; access to industry research through education seminars, newsletters, forums, and peer-to-peer consultations; an uncapped potential compensation; and marketing to clients. In an embodiment, an individual may opt out of being accessed for ranking.

In an embodiment, an individual may receive at least one benefit associated with a ranking. The benefit may be at least one of status and recognition through status flags displayed in a communication; continued eligibility for certain programs and events; unrestricted consultative relationships with clients; invitations to networking events; access to industry research through education seminars, newsletters, forums, and peer-to-peer consultations; an uncapped potential compensation; and marketing to clients. In an embodiment, the ranking may be based on at least two indicia related to engagement of the individual with clients, wherein each of the indicia is assigned a score, wherein the scores are normalized to allow for a ranking based on the normalized scores. The indicia may be at least one of repeat access of an individual by a single user, repeat access of an individual by non-correlated users, a frequency of access of an individual, a frequency of access of an individual by a single user, a frequency of access of an individual by non-correlated users, an increasing frequency of access of an individual, an increasing frequency of access of an individual by a single user, an increasing frequency of access of an individual by non-correlated users, a number of non-correlated users accessing an individual, a number of users accessing an individual, a number of repeat users accessing an individual, a number of articles published, a journal where an article is published, a citation to an article, a speaking engagement, a number of speaking engagements, an aspect of a speaking engagement, a conference attendance, an advisory board membership, an aspect of an advisory board membership, a position at a company, an award, a prestige of an award, a number of grants, a value of grants, an educational level, an educational institution attended, a level of education, a credential, a number of previous engagements, a number of previous engagements for an individual client, a number of clients per time period, a number of current engagements, a feedback rating, an amount earned, a demand for an expert, a supply, a referral to the expert network, a screening of projects for suitability and potential conflicts, an abiding by the terms and conditions for experts, a profile update, a participation in events, an availability, a publication rate, a citation rate, a current academic status, a current employment status, and a number of invited lectures.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following figures:

FIG. 1 depicts a logical block diagram of a knowledge logistics platform.

FIG. 2 depicts a logical flow diagram detailing steps in conflict management for experts.

FIG. 3 depicts a diagram detailing steps in populating a knowledge base.

FIG. 4 depicts a logical flow diagram detailing steps in conflict management for experts.

FIG. 5 depicts a process for accessing a taxonomy for creating a dynamic study group.

FIG. 6 depicts a process for ranking experts for membership in a qualification group.

FIG. 7 depicts a process for ranking experts by repeat access.

FIG. 8 depicts a process for ranking experts by a frequency of access.

### DETAILED DESCRIPTION

Various real-world projects involve bringing together experts to participate in collaborative work. These experts may be geographically dispersed; come from a wide variety of educational and experiential backgrounds; have a variety of work histories; be subject to different constraints that may be associated with availability such as time constraints, subject matter constraints, employer constraints, and so on. The following description relates to techniques for facilitating collaboration by a number of such experts from numerous professional fields.

An expert profiling system and/or a knowledge base may provide for identifying Council Members, Study Groups, or other experts. For example and without limitation, expert identification may include checking and/or managing of one or more of credentials, testimonials, expertise, conflicts, rate or total cost, timeframe/turnaround time, ranking or rating, portfolio of work, former collaborators, or other similar criteria.

Identification of experts may be associated with establishing participants in a project. For example, a client may wish to include an orthopedic doctor and a mechanical engineer on a project. The client may, for example, use the profiling system to identify the most qualified candidates, determine if those individuals are conflicted from working on the project or with one another, and determine if the candidates have had any experience working with one another specifically or with the other expert type.

Identification of experts may be associated with establishing an on-call advisory relationship. For example and without limitation, a client may not have a specific project that requires expert attention but may want to establish a relationship with an expert prior to a specific question or project arising that would require their assistance. For example and without limitation, a client in the field of medical devices may wish to have a translator as an on-call advisor should a question arise as to whether or not a foreign journal article pertains to one of the client's projects in development.

Identification of experts may be associated with identifying the most appropriate respondents for a survey. For example and without limitation, a client may wish to obtain data points and opinions across a large population of experts on a subject relating to real estate. Therefore, the client may want to identify realtors, developers, or real estate attorneys as potential survey respondents while avoiding, for example, film industry consultants and pharmacists.

Identification of experts may be associated with recruiting management. For example, a client may want to identify an external candidate for an in-house position. The system can be used to quickly search credentials, experience, expertise, potential conflicts, and other hiring factors to determine which individuals to recruit and how to recruit them.

Identification of experts may be associated with generating new profile questions. For example and without limitation, one or more of a client, expert, database owner, or other interested parties may suggest new profile information be stored for potential experts. For instance, a client may have identified a potential expert who was eventually deemed unsuitable because they lacked the skills to perform a novel, cutting-edge analytical technique. Such a scenario may lead to addition of, for example, information related to continuing education or most recent conferences attended.

Identification of experts may be associated with council management. For example and without limitation, a single expert may oversee a group of experts with similar attributes. The overseeing expert may be identified using expert profiles.

Identification of experts may be associated with council programs. For example, a council program may be an inter-disciplinary roundtable discussion on the impact of a recent lawsuit on the pharmaceutical and medical device industry. To populate the panel for the program, experts in regulatory law, pharmaceuticals, and medical devices may be identified.

Identification of experts may be associated with establishing a professional network. For example, a client, expert, or other interested party may want to establish a professional network in a new industry. The interested party may identify experts who they may then contact regarding establishing their professional network.

Identification of experts may be associated with performance analytics. For example, an expert may be identified to serve as a peer reviewer for another expert in a similar field.

Identification of experts may be associated with testing messaging systems. For example, efforts to improve communicating with large groups of individuals efficiently may be done by using the pool of experts as a test case.

Identification of experts may be associated with compliance management. For example, an individual expert participating in a large collaborative project may be identified by the system as potentially not having complied with their contract if client or expert meetings have not been scheduled or their work portfolio has not been updated. Another example may relate to compliance associated with conflict management. For projects where a potential conflict may have been identified, the system may identify whether a conflict waiver has been obtained and whether meetings and work have proceeded in the absence of such waiver.

Identification of experts may be associated with notification or watch lists. For example, experts who may be interested in receiving news relating to an important client may be identified by their past work with the client, past work with the client's competitor, or their stated expertise.

Identification of experts may be associated with assigning management responsibilities. The most appropriate expert to assign a management responsibility can be identified by querying expert profiles, for example.

Identification of experts may be associated with identifying supply and demand metrics. For example, identification of experts with the greatest number of projects may indicate a demand for that type of expert.

Identification of experts may be associated with many things that will be appreciated. All such things are within the scope of the present disclosure.

Systems and methods for capturing expert and consultant inputs may be directed at formal instruction and interactive discussion, rapid and on-demand insight, acquisition of data points and opinions across a large population (25-100) of Council Members, field research in any region of the world, office visits, translation services, exclusive consulting relationships, and the like and combinations thereof.

Capturing expert and consultant input may comprise formal instruction and interactive discussion. For example, a roundtable format may be used to capture expert input. The roundtable may be, for example, an interactive lecture, which may be optionally led by a Leader. The interactive lecture may optionally include a detailed workbook that is distributed to attendees. Another example may be an education seminar. The education seminar may be a discussion between a Council Member and a small group of clients, generally informal to optimize for collaborative conversation. Yet another example may be a master class. The master class may be programmed or customized. The master class may comprise extensive on-site training, aimed at teaching key issues or desired skill sets.

Capturing expert and consultant input may comprise rapid, on-demand insight. For example, a telephone consultation may be used to provide rapid, on-demand insight. A telephone consultation can be used to arrange further consultation with an expert or, based on a client query, identify the most relevant and appropriate Council Members for future consultations. During a telephone consultation, additional populations that were not originally considered may be suggested. Telephone consultations may also be used to qualify Council Members for participation by their responses to taxonomy-based questions, availability, Member Program status, and the like. Another example of rapid, on-demand insight may comprise a non-collaborative report. The non-collaborative report may be a single author report, written answers to questions, and the like.

Capturing expert and consultant input may comprise acquisition of data points and opinions across a large population (25-100) of Council Members. An example of this may include, for example, conducting surveys. A survey platform allows clients to match their questions to the precise expert respondents most appropriate to answer them. Questions in a survey quantitative and qualitative question types. Surveys can be run in a recurring fashion to enable time-based analysis and assessment.

Capturing expert and consultant input may comprise field research in any region of the world. For example, interactions with leading local Council Members can be arranged on short notice and on any subject. A multi-day program can be arranged featuring a full schedule of meetings with Council Members in a particular region. Programs may include tours of industry sites and facilities. The complexities of in-region scheduling are minimized through the knowledge logistics platform. Another example includes programmed travel. Such travel can be organized around a theme of common interest and may optionally be developed for a small group of clients. Travel programs can also be customized and may optionally be developed for a single client.

Capturing expert and consultant input may comprise a visit to the office of a client, expert, or other interested party. The office visit may involve one client or multiple clients. The office visit may involve one expert or multiple experts.

Capturing expert and consultant input may comprise a translation. For example and without limitation, a client may request a translation of a Korean patent. Therefore, the client may identify a Korean-speaking patent attorney or a Korean-speaking technologist in the field of the patent.

Capturing expert and consultant input may comprise engaging in an exclusive consulting relationship. For example and without limitation, a client may request the services of an identified expert on an exclusive basis. If the expert chooses to engage in such a relationship, they may not be able to participate in projects with other clients for the duration of the exclusivity.

Capturing expert and consultant input may comprise any combination of the foregoing. The use of one system/method for capturing expert and consultant inputs can be followed with or bundled with another. For example and without limitation, a survey can be followed up with a telephone consultation. Another example may include an office visit followed up by a roundtable discussion.

The Council may comprise experts from one or more professions, such as physicians, lawyers, accountants, scientists, engineers, translators, and other similar professions.

The Council may also comprise professionals with a distinct industry focus to their expertise. For example and without limitation, Council Members may be considered experts in a healthcare field. Examples of healthcare fields may be allergy, immunology, anesthesiology, cardiology, dentistry, orthodontics, dermatology, drug distribution, emergency medicine, endocrinology, gastroenterology, genetics, genomics, group purchasing organizations, healthcare staffing and recruiting services, healthcare consultants, healthcare information technology, hematology, hepatology, hospitals, health systems, infectious disease, long term care services, managed care, medical devices and supplies, nephrology, neurology, OB/GYN and women's health, oncology, opthalmology, orthopedics, pain medicine, pediatrics, pharmacy benefits consultants, physician practice management, psychiatry, pulmonary, radiology, rheumatology, surgery, urology, and veterinary, and the like.

The Council may comprise professionals who are considered experts in technology, media and telecommunications. Examples of experts in technology, media and telecommunications may include cable and broadcast network consultants, cable MSO and satellite consultants, digital media executives, enterprise telecommunications consultants, film industry consultants, former CIO's and IT directors, IT hardware channel, IT infrastructure software channel, media buyers, media planners, music industry consultants, paid search consultants, residential telecommunications consultants, semi components market research, semicap and manufacturing consultants, small business application software channel, video game retailers, Voice-over-IP consultants, wireless retailers, and the like.

The Council may comprise professionals who are considered experts in consumer goods and services. Examples of experts in consumer goods and services may include franchisees of restaurant companies, used and new car dealership sales and general managers, sales representatives and distributors for cosmetics and personal care products, travel agents and owners of independent travel booking firms, apparel distributor and sourcing agents, independent tool manufacturer's representatives and distributors, food distributors and brokers, furniture distributors and importers, alcoholic beverage distributors, independent toy manufacturer's representatives and distributors, independent jewelry and gem distributors and manufacturer's representatives, and the like.

The Council may comprise professionals who are considered experts in energy and industrials. Examples of experts in energy and industrials may include agricultural and construction equipment dealership and rental company general managers, airline training and simulation center owners, building materials distributors (e.g.: lumber), commodities brokerages (e.g.: coal, metals, silver), ethanol plant operators, HVAC dealership owners, industrial automation equipment manufacturers representative, owners and sales managers at carpet retailers, owners and sales managers at heating oil distributors, sales managers at chemicals marketers, scrap and recycling company managers, truck dealership owners, trucking service owner-operators, waste-to-energy facility owners, and the like.

The Council may comprise professionals who are considered experts in financial and business services. Examples of experts in financial and business services may include catastrophe modeling firms, claims advisory services, ISO sales managers, independent benefit consulting firms, independent financial planners/consultants, independent insurance agents, independent residential and commercial mortgage brokers, risk management consultants, securities traders/brokers, specialty actuarial consulting firms, and the like.

The Council may comprise professionals who are considered experts in legal, economic and regulatory affairs. Examples of experts in legal, economic and regulatory affairs may include directors and lobbyists of major industry trade associations, economists focused on economic trends, monetary policy and antitrust issues, international partner-level attorneys focused on foreign direct investment and cross border transactions, international trade lobbyists, economists and former negotiators, labor and union negotiation specialists, leading U.S. governmental policy and agency experts, partner-level antitrust and M&A attorneys, partner-level bankruptcy and restructuring attorneys, partner-level class action, toxic tort and product liabilities attorneys, partner-level patent attorneys focused on bio-technology, partner-level patent attorneys focused on technology, and the like.

The Council may comprise professionals who are considered experts in accounting and financial analysis. Examples of experts in financial analysis may include Big 4 accounting partners, forensic accountants, former Fortune 500 CFOs, former IRS examiners, former SEC accounting officials, leading accounting professors from the world's top business schools, and the like.

The Council may comprise professionals who are considered experts in real estate. Examples of experts in real estate may include commercial property developers, corporate real estate executives, general and specialty trade contractors, investment sales brokers, land acquisition professionals, leasing agents, production home builders, realtors, REIT executives, portfolio appraisers/surveyors, property managers, and the like.

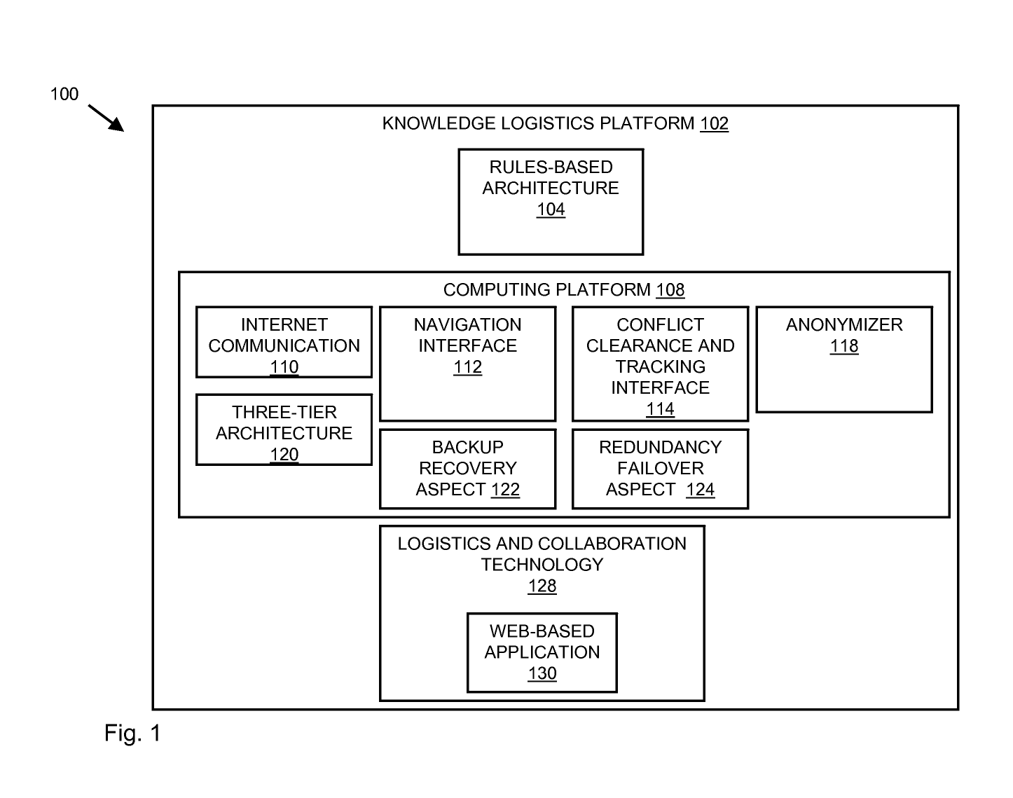

Referring to FIG. 1, a knowledge logistics platform 102 may comprise a rules-based architecture 104 for compliant collaboration and consulting, a computing platform 108, logistics and collaboration technology 128, or similar technology and systems. The platform may promote and support interactions between experts, wherein the interactions are directed at providing services and/or work product to a client. For example and without limitation, a client may utilize the platform to locate an appropriate expert or group of experts who could provide a formal instruction and interaction discussion; a rapid, on-demand insight; an acquisition of data points and opinions across a large population of experts; research in any region of the world; an office visit; a translation service; consulting; ongoing consulting engagements; report drafting; and so on. In any event, any of these interactions may take place either in-person, not in person, or some combination thereof.

The rules-based architecture 104 for compliant collaboration and consulting enables decision-makers and other professionals to connect to specialized and qualified experts by simplifying the tasks of profiling, identifying, and contracting with subject matter experts. For example and without limitation, a decision-maker may specify that he is interested in consulting with a group of experts whose collective expertise covers a particular subject area and who have a proven track record of working well together. The rules-based architecture 104 may provide such a group of experts through the application of rules that are associated with the decision-maker's specification.

A computing platform 108 allows Council Members, Study Groups, Councils, Cohorts, and other experts to communicate via internet, telephone, pager network, or other such communication method with clients. A Council may be a distinct industry or discipline-specific group associated with a practice where each Council is composed of one or more Council Members. A Cohort may be a group of collaborators. A Study Group may be a group of individuals with similar attributes. Communication via the internet 110 comprise an email, an instant message, an internet relay chat, an RSS feed, a web-based communication method, and so on. The web-based communication method 110 may be associated with a wiki, a blog, a forum, a bulletin board, SMS, some other web-based communication method, and the like. Telephone communication may include conversation, teletype or other telecommunications devices for the deaf, interactive voice response, SMS, MMS, and so on.

A Council may be a distinct industry or discipline-specific group associated with a practice. A Council may allow professionals for every sub-sector, global region, and level of professional experience to exchange opinions, ideas, and best practices. A Council's blend of breadth and depth enables clients to connect with appropriate education resources on any subject. For example and without limitation, a Council on political leadership may be populated by former Heads of State from any country around the world, political analysts from various media outlets, leading professors in government and law, and the like. Each Council is composed of one or more Council Members.

A Cohort may be a group of collaborators. The collaborators in the Cohort may have worked together extensively on many projects or on a single project. The projects may be client-initiated projects, Council-initiated projects, third party-initiated projects, collaborator-initiated projects, projects completed prior to formation of the Council, and the like. For example and without limitation, a Cohort may comprise an NIH Advisory Panel that met from 1999 to 2001 and were charged with developing guidelines for stem cell research. Some participants in the Panel may be Council Members while others may not. Nevertheless, identification of the Cohort will allow identification of all of its participants, including current Council Members, former Council Members, and non-Members alike.

A Study Group may be a group of individuals with similar attributes. Study group membership may be dynamic or static. A Study Group may convene to advance similar interests. For example and without limitation, a Study Group of psychiatrists may convene on a monthly basis to discuss the latest advances in the treatment of various psychiatric disorders. A Study Group may also be called upon to establish guidance for a particular industry or discipline. For example and without limitation, the Environmental Protection Agency may request a Study Group for establishing general risk management guidelines for wastewater treatment plants. The Study Group may comprise experts in the fields of wastewater treatment, environmental chemistry, health physics, solid waste management, and the like. In this example, the Study Group may discuss various aspects of risk management for wastewater treatment plants, such as handling of hazardous materials and inspection of treatment tanks, in order to arrive at a consensus for industry-wide risk management guidelines. A Study Group may also be called upon to participate as respondents to a survey. For example and without limitation, a client may require a Study Group for a survey concerning the impact of technology on education. The Study Group membership may comprise experts that classify themselves as educators, technologists working in the field of education, sociologists interested in education, and the like. Other reasons for calling upon a Study Group may be appreciated and all such reasons are within the scope of the present disclosure.

The computing platform 108 may comprise a navigation interface 112, which allows users to identify Council Members, Study Groups, Councils, Cohorts, or other experts. Expert identification may be facilitated by navigation of expert profiles and knowledge base. For example and without limitation, expert identification may include checking and/or managing of one or more of credentials, testimonials, expertise, conflicts, rate or total cost, timeframe/turnaround time, ranking or rating, portfolio of work, former collaborators, or other similar criteria.

The computing platform 108 may comprise a conflict clearance and tracking system 114, which may enable various types of assertions and disclosures. The system 114 may enable assertions by a platform or network regarding a conflict or restriction by an expert, based upon a platform or network policy. The system 114 may enable disclosures by the expert regarding a conflict or restriction that he or she admits to have, wherein this admission is proactively provided by the expert or provided by the expert in response to a specific question. The system 114 may enable assertions by a third-party stakeholder regarding an expert's conflicts or restrictions. These conflicts or restrictions may, without limitation, be associated with a current or past employer or client of the expert. In embodiments, the assertions and disclosures may be stored in an unstructured or taxonomic framework. It will be appreciated that a taxonomic framework may provide greater accuracy and extensibility as compared with an unstructured framework. Assertions and disclosures may related to subjects (such as and without limitation products, services, assets, issues, and the like); companies; business units; types of expert interactions; and so on. Depending upon the types of assertions or disclosures, restrictions may be implied and/or applied immediately. Alternatively, restrictions may be temporarily applied, pending a response to or rejection of the restriction from an expert, client, third party, and so on. Many other assertions and disclosures will be appreciated and all such assertions and disclosures will be appreciated. Likewise, it will be appreciated that assertions and disclosures may be provided by others sources and/or according other methods, all of which are within the scope of the present disclosure.

Systems and methods for coordinating the solicitation and contribution of multiple experts may be directed at avoiding a conflict for and/or between one or more of the experts. For example, and without limitation, an expert providing advice to a first party may be deemed damaging to a second party if the second party may already be a client of the expert. In addition to appearances of conflict, the expert consulting with a first party on the topic on which the first party has discussed confidential information with the second party, may be more likely to lead an unhelpful conversation since the expert will be limited in what they can discuss or, worse, may discuss the confidential information inadvertently. Since numerous other situations can also give rise to conflicts or appearances of conflicts, which can result in the expert being unable to engage with a potential client on a project, determining whether a particular individual expert may be or should be conflicted from working with a potential client may be an important and time-sensitive task.

There may be multiple ways that potential conflicts and restrictions may be identified, perceived, or disclosed including performing conflict checks via hard copy memorandum, e-mail, telephone call, SMS, instant message, or some other such communication. For instance, a group of experts could be polled via e-mail for any potential conflicts with a prospective client. A review of the accumulated responses may be necessary to determine which expert should be assigned to the client's project. A much faster and more efficient method to assess whether or not a conflict exists would involve an automatic process. For example, and without limitation, upon identifying a client, a database containing expert attributes may be manually or automatically queried to ascertain whether a potential conflict or restriction exists. Those experts with no conflicts may be given the opportunity to work on projects with the client while those experts who may be conflicted may either be prohibited from working on the client's project or, once told or reminded of the conflict, the expert and client may choose to proceed based on those limitations or obtain a conflict waiver. In embodiments of the present invention, an automatic or manual process may draw upon a database of one or more taxonomies to create questions and/or make inferences with respect to whether or not an expert has a conflict with regard to particular subject matter, a particular corporate matter, and so on. Other approaches to generating questions for an expert and/or inferring conflicts for the expert may be appreciated and all such approaches are within the scope of the present disclosure.

The computing platform 108 may comprise a backup or recovery aspect 122. For example, data stored on the communications, application, and database servers may be duplicated so that if the original data are damaged or lost, the data can be restored. Also, data for projects that have already been completed may be archived.

The computing platform 108 may also comprise a redundancy or failover aspect 124. For example, groups of collaborators, such as cohorts, may be stored so that it is easy to find groups of experts who have worked together in the past.

The computing platform 108 can be customized based on a set of preferences. Preferences may be defined by one or more of experts, clients, database owners, or other interested parties. Preferences may be arranged according to a taxonomy.

Systems and methods for coordinating the logistics and collaboration of projects may be directed at the management of meetings, consultations, and collaboration through the use of web-based applications 130. For example and without limitation, a logistics tool may be used to allow clients to manage any and all stages of a research project. Stages of a research project may comprise expert/consultant invitation, screening, scheduling, collaborative and non-collaborative report preparation, payment, and similar stages.

Interaction scheduling and project management may be facilitated by logistics and collaboration technology 128. For example, in-person meetings and other consultations may be scheduled using a web-based scheduling system. The scheduling system may be accessed and modified by one or more of clients, experts, and other interested parties. The system can be used to schedule one-on-one meetings, collaborative meetings with multiple experts and/or multiple clients, recurring meetings, one-time meetings, and the like.

Another example of interaction scheduling and project management may comprise a survey platform. The survey platform may facilitate an acquisition of data points and opinions across a large population of experts. For example, if a client wishes to obtain the aggregate advice of multiple experts, they may use the survey platform to target multiple experts simultaneously. The survey platform may allow clients to match their questions to the precise expert respondents most appropriate to answer them. Clients can run recurring surveys, thus enabling time-based analysis and assessment. Surveys may be designed and interpreted by one or more of clients, experts, or other interested parties. Surveys may comprise either quantitative or qualitative question types.

Another example of interaction scheduling and project management may comprise collaborative document creation and annotation tools. For example, some projects may involve multiple experts, or a client and an expert, collaborating on document creation and/or document annotation. An example of such collaboration may comprise an expert using the system to create a document, which is annotated by the client and then further developed by a second expert.

Ongoing consultative relationship management may be facilitated by logistics and collaboration technology 128. For example, the system may enable a client to build and access a ‘personal consulting group’ of proven experts who can be directly accessed at any time, after a qualifying and scheduling process.

Payment management may be facilitated by logistics and collaboration technology 128. The system may facilitate compensation for expert time. For example, the system may be used to facilitate payment in the expert's country, in multiple currencies and formats, and for any type of project arranged through the platform.

Project search and archiving may be facilitated by logistics and collaboration technology 128. For example, the system may enable search and retrieval of past project details, including profiles for all experts considered or utilized. Projects may be searched by topic, client, expert, date, and other such criteria and combinations thereof.

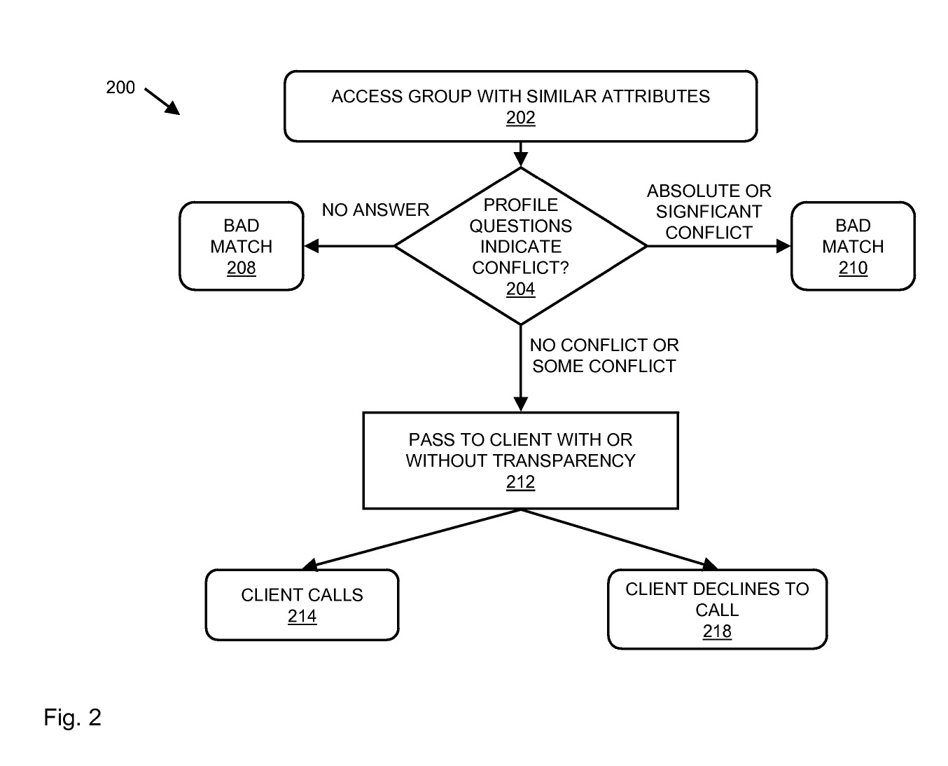

Referring now to FIG. 2, an aspect of the invention may involve a process for conflict identification, disclosure, restriction assertion, management, and the like 200. Starting at logical block 202, a group of expert individuals with similar attributes may be accessed. Processing flow may continue to logical block 204, where an invitation comprising profiling questions, which may or may not be taxonomy-based, may be sent out to certain members of the group while other members of the group may be excluded from receiving such an invitation. Also as indicated by logical block 204, answers related to the profile questions may be received and a test may determine whether the questions have not been answered and, if they have, whether the answers indicate a no conflict, some conflict, significant conflict, or an absolute conflict. If the profiling questions are not answered, the expert may be deemed a bad match to the client, project, or the like and processing flow may continue to logical block 208 where processing may terminate. If answers to the profiling questions indicate a conflict, the expert may be deemed to be a bad match to the client, project, or the like and processing flow may continue to logical block 210 where processing may terminate. If the profiling questions indicate no or only some conflict, processing flow may continue to logical block 212 where the potential match may be communicated to the client with or without transparency as to the details of the potential conflict. The client may be given an opportunity to assess the potential conflict. The client may choose to engage the expert 214 (such as and without limitation by calling the expert) or decline such an engagement 218 (such as and without limitation by declining to call the expert).

In any case, a taxonomy may be a classification of subject matter (e.g.: products, services, assets, issues, and the like), a classification of experience, a classification of conflicts/restrictions, a company classification (e.g.: corporate tree, subsidiaries, business units), a preferences classification, a classification of types of expert interactions, and the like. For example and without limitation, a subject matter taxonomy related to novel targets for cardiovascular drugs may involve multiple levels. The top level may be physiology. The next level may comprise various physiological systems, such as the cardiovascular system, the neurological system, the epidermal system, and the like. There may be various sub-levels in the subject matter taxonomy for each of these systems. The next levels in the branch of the taxonomy related to the cardiovascular system may be, for example, heart, lungs, arteries, veins, capillaries, and the like. There may be various sub-levels in the subject matter taxonomy for each of these cardiovascular elements. The next level in the branch of the taxonomy related to the heart may be, for example, cardiomyocytes, myofibrils, Purkinje fibers, and the like. There may be various sub-levels in the subject matter taxonomy for each of these heart elements. The next levels in the branch of the taxonomy related to Purkinje fibers, for example, may be sodium channels, potassium channels, beta-adrenergic receptors, a novel target for cardiovascular drugs, and the like.

Another example of a taxonomy may be a conflicts/restrictions taxonomy. For example, and without limitation, the top level of a conflicts taxonomy may comprise a client-expert relationship, a project-expert relationship, an expert-expert relationship, and the like. There may be various sub-levels in the conflicts taxonomy for each of these relationships. The next levels in the branch of the taxonomy related to a client-expert relationship may be conflicts with the client or client type conflicts due to a current or former employment or consultancy, conflicts due to a communication type, restrictions due to cost, restrictions on matches without approval of an interested party, restrictions as to an exclusivity, restrictions due to a time constraint, restrictions on ability to work with a company or subset of companies, restrictions as to geographic region, restrictions based on local law, and the like. The next levels in the taxonomy related to each of these types of conflicts may be a conflict management type. For example and without limitation, the next level in the branch of the taxonomy related to conflicts due to a current or former employment or consultancy may comprise soliciting a conflict waiver, obtaining a conflict waiver, being barred from working with the client, and the like. In another example, the next level in the branch of the taxonomy related to conflicts due to a communication type may comprise modifying the communication type, obtaining assistance from a translator, being barred from working with the client, and the like.

Multiple, individual taxonomies may be linked together or feed into one another, as in the example described above. Additionally, each branch of a taxonomy may represent its own taxonomy. Many taxonomies will be appreciated and all such taxonomies are within the scope of the present disclosure.

In order to identify potential conflicts, taxonomy-based profiling questions may be used to obtain relevant information about an expert. Taxonomy-based profiling questions may be generated manually or automatically. Taxonomy-based profiling questions may be administered manually or automatically. Responses to taxonomy-based questions may be obtained manually or automatically. Responses to taxonomy-based questions may be stored in a knowledge base, user profile, conflict registry, database, and the like. The knowledge base and user profile may comprise information that is associated with potential, inferred, and known conflicts, restrictions, subject matter expertise or lack thereof, inferred subject matter expertise or lack thereof, experience, availability, interest, comments, and the like. The conflict registry may comprise potential conflicts, inferred conflicts, known conflicts, waived conflicts, and the like. Responses to taxonomy-based questions derived from one taxonomy may result in or be associated with generating an inference drawn from that taxonomy, an inference drawn from other taxonomies, an additional taxonomy-based question related to the same or a different taxonomy, and the like. For example, and without limitation, a client in the pharmaceutical industry may wish to obtain expert advice on developing agents directed at novel targets in the cardiovascular system. An initial profiling question 304 may be related to a subject matter taxonomy, for example, “Are you familiar with the cardiovascular system?”. If the answer is “Yes”, additional profiling questions 304 may be asked to further assess the expert's potential conflicts, restrictions, relevant experience, subject matter expertise, and the like. Additionally, the positive response may be stored in a user profile, knowledge base, database, and the like. If the answer is “No”, further profiling questions may not be necessary. Additionally, the negative response may be stored in a user profile, knowledge base, database, and the like. If the answer is “I am not allowed to speak on the subject” or a similar answer, a potential conflict or restriction may be inferred. One or more additional profiling questions, any and all of which may be taxonomy-based questions, may be generated and/or put to the expert. These questions may be directed at ascertaining the nature of the potential conflict or restriction. Additionally, the answer to the initial question and any and all follow-up questions may be stored in a knowledge base, user profile, conflict registry 308, database, and the like.

A second, follow-up profiling question may be related to a conflicts taxonomy, for example, “Have you ever been employed by a company whose work is related to the cardiovascular system?”. A positive response, which may be stored in a user profile, knowledge base, database, and the like, may indicate a potential conflict, restriction, subject matter expertise, relevant experience, and the like. A positive response may be followed-up with additional profiling questions, such as, and without limitation, one or more of the following questions, which may be taxonomy-based and/or presented in any order: “Was your employer Bausch & Lomb?”, “Did your work involve developing contact lenses?”, “Did/does your work relate to Bausch & Lomb Boston™ Brand Gas Permeable contact lenses?”, and the like. Responses to these additional follow-up questions may be stored in a user profile, knowledge base, database, conflict registry, and the like. A negative response to any and all of these questions, which may be stored in a user profile, knowledge base, database, conflict registry, and the like, may indicate a lack of experience or subject matter expertise. However, based on a negative response, the absence of a potential conflict or restriction may be inferred. Additional follow-up profiling questions, which may be taxonomy-based and may be akin to the aforementioned profiling questions, may be put to an expert so as to further assess the expert's potential conflicts, relevant experience, subject matter expertise, and the like. Responses to the additional follow-up questions may be stored in a user profile, knowledge base, database, conflict registry, and the like. Many other profiling questions, whether or not they are taxonomy-based, will be appreciated. All such profiling questions are within the scope of the present disclosure. Responses to various profiling questions may be used to make an assessment as to an expert's potential or inferred conflicts, restrictions, experience, subject matter expertise, availability, communication preferences, and the like. Responses to various profiling questions may be used to make a match between an expert and a client. Responses to various profiling questions 304 may be stored in a user profile, knowledge base, database, conflict registry, and the like.

Taxonomy-based questions may be relatively broad or relatively more granular. Relatively broad questions may be drawn from the higher levels of a taxonomy while relatively granular questions may be drawn from lower levels of the taxonomy. Taxonomy-based questions, which may be directed at gaining and/or inferring information about an expert, may be asked in a broad-first order, granular-first order, random order, or any and all other orders. For example, and without limitation, a granular question related to the cardiovascular subject matter taxonomy described above may be “Are you familiar with cardiomyocytes?”. From a negative response, it may be inferred that the expert is not familiar with any of the elements below cardiomyocytes in the taxonomy. However, it may not be possible to infer familiarity with elements above cardiomyocytes in the taxonomy. From a positive response, it may be inferred that the expert is familiar with all of the elements above cardiomyocytes in the taxonomy. However, it may not be possible to infer familiarity with elements below cardiomyocytes in the taxonomy.

Profiling questions may also be unstructured or not drawn from a taxonomy. For example and without limitation, various biographical questions may be generated and/or put to the expert such as and without limitation, “Do you reside on the East Coast?”, “What is your age?”, and “What is your billing rate?”. Certain responses to these questions may indicate a potential conflict or restriction. Responses to various profiling questions may be used to make a match between an expert and a client. Responses to various profiling questions may be stored in a user profile, knowledge base, database, conflict registry, and the like.

The system may support proactive disclosure of potential conflicts or restrictions by adding information to or updating a user profile, knowledge base, database, conflict registry, and the like by one or more of employers, experts, clients, database owners, other interested parties, and the like. Limitations and restrictions on ability to work with specific clients, client types, experts, subjects, communication types, languages, specific days, specific times, and the like may be asserted and added to or updated in a user profile, knowledge base, database, conflict registry, and the like. For example and without limitation, an employer may assert a restriction on the expert's ability to work with clients in the same industry. The employer may further assert that a match may be made as long as the employer has the opportunity to approve such a match, as long as they are copied on any communications between the client and the expert, and the like. An example of another restriction may be an expert not being able to work on religious holidays, weekends, vacations days, and the like.

A user profile, knowledge base, database, conflict registry, and the like may be manually or automatically searched for potential conflicts, experience, subject matter expertise, availability, communication preferences, and the like to either qualify or disqualify an expert. For example and without limitation, when a new project is identified, it can be cross-referenced or normalized to a taxonomy either through a client input interface or manually. Conflicts, restrictions, expertise, and the like stored in a user profile, knowledge base, database, conflict registry, and the like may be automatically cross-referenced.

Rules may be associated with an identified conflict, restriction, expertise, and the like. The rules may be applied to and/or associated with a project, a conflict, a client, an expert, a third party, an amount of time spent on a project, an amount of time spent in aggregate, a dollar amount, a minimum dollar amount, a maximum dollar amount, a dollar amount that is associated with an expert's work on a particular project or on any and all projects in aggregate, a company, a set of companies, a taxonomy of companies, a topic of subject matter, a competitor, and so on.

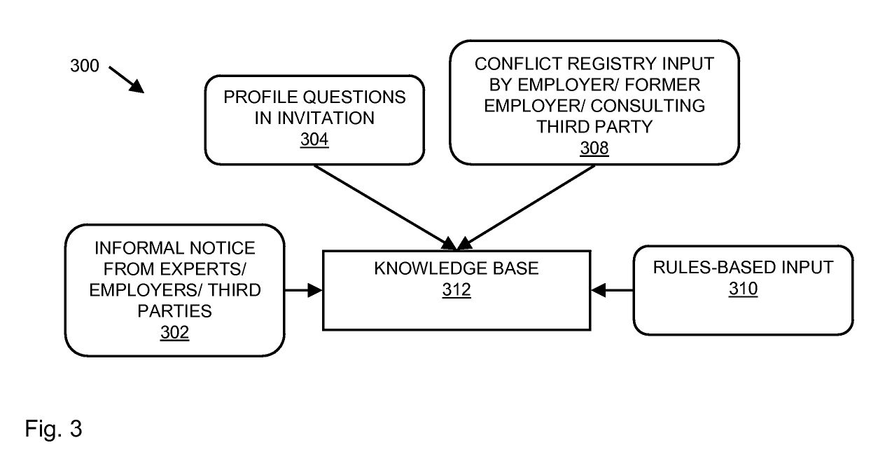

Referring now to FIG. 3, answers or input that is associated with profile questions in an invitation 304; a conflict registry 308; informal notice from experts, employers, third-parties, and the like 302; rules-based input 310; and so forth may populate a knowledge base 312. The rules-based input 310 may comprise or be associated with the rules that are described herein with reference to FIG. 1 and elsewhere. The knowledge base 312 may be searched for many different types of information that may readily be appreciated. For example and without limitation, a user profile, knowledge base 312, database, conflict registry, and the like may receive inputs from responses to profiling questions 304; conflict disclosures from one or more of experts, current or former employers or consulting third parties, and other interested parties 308; informal notice from experts, current or former employers or consulting third parties, and other interested parties 302; rules-based inputs 310; and the like. Population, update, and search of information in a user profile, knowledge base 312, database, conflict registry, and the like may be taxonomically-driven or may occur in an unstructured manner. All such things, whether described herein or appreciated from the present disclosure, are within the scope of the present disclosure.

An outcome of any and all of the tests within the process may be influenced by an external input. In embodiments, an employer, expert, client, database owners, or any and all other interested parties may provide and/or be associated with this input.

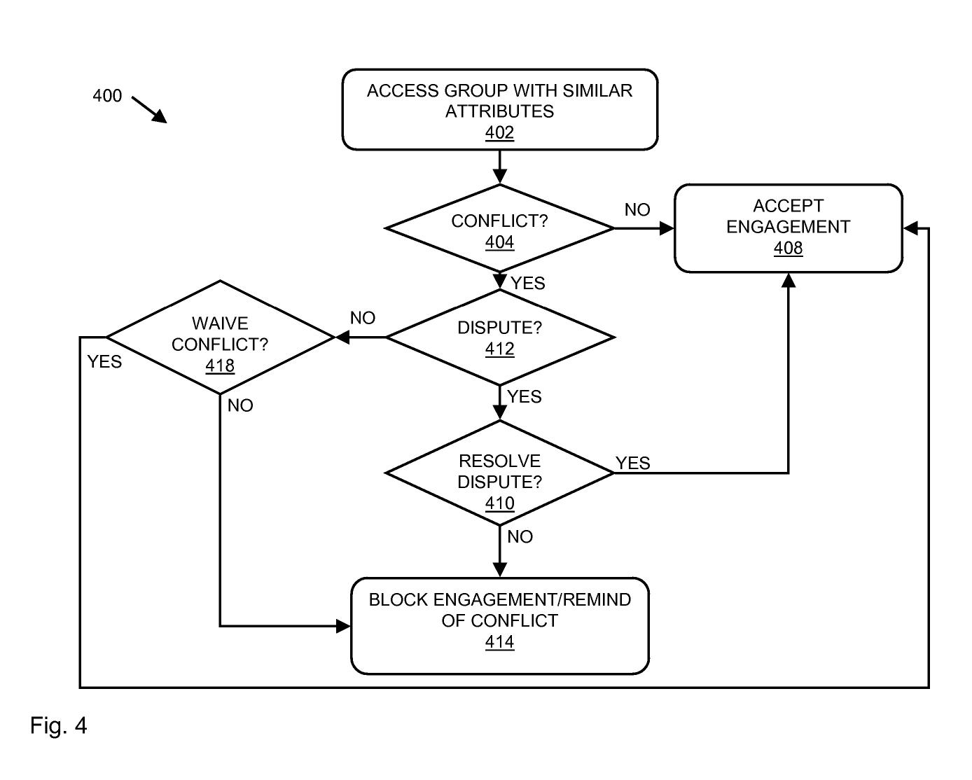

Referring now to FIG. 4, an aspect of the invention may involve a process for conflict management 400. Process flow may begin with a group of expert individuals with similar attributes being accessed 402 when a customer indicates a need for an expert. Processing flow may continue to logical block 404 where potential conflicts, which may relate to an expert-client relationship, an expert-expert relationship, an expert-subject-matter relationship, and the like, may be determined for each individual in the group of experts. One or more of employers, experts, clients, database queries, database owners, and the like may identify a potential conflict. Conflicts may comprise limitations based on current or recent employment, specific subjects that the expert cannot discuss, types of interactions that may be forbidden or limited such as a telephone call, an e-mail, an instant message, an SMS, a page, or similar interactions, specific clients or client types that may be forbidden or limited, date or time conflicts such as availability, and other similar potential conflicts. In embodiments, potential conflicts and known conflicts may be arranged within a taxonomy or identified using a taxonomy.

In the absence of conflicts, the expert may be free to accept the project with the client and processing flow may proceed to logical block 408. Optionally, acceptance of a match may be mandatory, thus, the expert or the client may not have the opportunity to accept or decline a match. However, if a conflict exists, processing flow may continue to logical block 412 where a test may determine if the conflict is disputed. If the result of this test is affirmative, processing flow may continue to logical block 410. However, if the result of the test is negative, processing flow may continue to logical block 418. At logical block 412, one or more of employers, experts, clients, database owners, or other interested parties may dispute the conflict. Such a dispute may be associated with allowing one or more of employers, experts, clients, database owners, or other interested parties to challenge the validity of a potential conflict. A conflict may be resolved at logical block 410 by either obtaining a waiver or by obtaining a new finding that the conflict does not exist or may be moot. If a waiver or a new finding be discovered to resolve the dispute then processing flow may continue to logical block 408, where the expert may be free to accept the proposed project. However, if the dispute fails to resolve the conflict, processing flow may continue to logical block 414, where the potential project may be blocked and/or a reminder of the conflict may be generated.

Upon acceptance of a conflict identified through responses to profiling questions or automatically generated by the system's review of information stored in the user profile, knowledge base, database, conflict registry, and the like, the expert may not be invited to participate in the project, may be barred from participating in the project, or the potentially conflicted match may be communicated to the client with transparency, or information regarding the details of the conflict. The client may then choose to proceed with the match and grant her approval of the match or they may choose to decline the match. Approval of the match may be limited to registered approvers, who may include experts, clients, third parties, and the like. Approval of the match may be contingent upon disclosure of a conflict, a minimum or maximum applied to an expert's fees vis-à-vis any and all projects alone or in aggregate, providing notice to a third party, and so on. Registered approvers may only be allowed to make certain kinds of approvals and not others. For example and without limitation, the most senior manager at a large company may be able to approve experts for any of the company's projects, while a lower-level project manager may only grant approval for experts on his own projects. In some cases, multiple potentially conflicted matches may be identified and presented to a client in the form of an approval queue. An automatic block of the potentially conflicted match may occur. Automatic block of the match may comprise elimination of the expert from a group of potential experts, non-generation of an invitation to participate in a project, retraction of an invitation to participate in a project, permitting the match with imposed restrictions, or the like. Alternatively, the accepted conflict may be waived at logical block 418 by one or more of employers, experts, clients, database owners, or any and all other interested parties. Once a conflict has been waived, processing flow may proceed to logical block 408, where the expert may be free to accept the engagement or project with the client. However, if the conflict is not waived at logical block 418, then processing flow may continue to logical block 414, where a reminder of the conflict may be generated and communicated to the expert 414.

An outcome of any and all of the tests within the process 400 may be influenced by an external input. In embodiments, an employer, expert, client, database owners, or any and all other interested parties may provide and/or be associated with this input. Any and all of the processes and elements of processes within any and all of the figures provided herein and elsewhere may be performed manually or automatically.

In summary, the process 400 may begin at logical block 402, where the process may access one or more individuals of a group. For each individual, logical flow may proceed to logical block 404, where a test may determine whether the individual has a conflict with respect to a particular client, project, subject, or the like. If the result of this test is negative, logical flow may proceed to logical block 408, where an engagement might be associated with the client, project, subject, or the like may or may not be accepted. However, if the result of the test is affirmative, then logical flow may proceed to logical block 412, where a test may determine whether the conflict is in dispute. If the result of this test is negative, logical flow may proceed to logical block 418 where a test may determine whether the conflict is waived. If the result of this test is affirmative, logical flow may continue to logical block ACCEPT ENGAGEMENT 408, where the engagement may be accepted. Otherwise, logical flow may proceed to logical block BLOCK ENGAGEMENT/REMIND OF CONFLICT 414 where the individual's participation in the engagement may be blocked and/or a reminder of the conflict may be communicated with any and all of the interest parties. However, if the result of the test at logical block 412 is affirmative, then from there logical flow may proceed to logical block 410 where a test may determine whether the dispute can be resolved. If the result of this test is affirmative, then logical flow may continue to logical block 408. Otherwise, logical flow may continue to logical block 414. In any case, logical flow may terminate upon reaching logical block 408 or 414.

All of the elements of the method for conflict management 400 may be depicted throughout the figures with respect to logical boundaries between the elements. According to software or hardware engineering practices, the modules that may be depicted may in fact be implemented as individual modules. However, the modules may also be implemented in a more monolithic fashion, with logical boundaries not so clearly defined in the source code, object code, hardware logic, or hardware modules that implement the modules. All such implementations may be within the scope of the present disclosure.

The computing platform 108 may comprise an anonymizer 118. The anonymizer 118 may remove personally identifying information from communications between one or more of employers, experts, clients, database owners, or other interested parties. For example, a potential client may request to review the curriculum vitae for the most highly ranked biochemistry expert. Before the system provides the curriculum vitae to the potential client, it may be stripped of personally identifying information by the anonymizer 118.

The computing platform 108 may comprise a three-tiered architecture 120. The three-tier architecture 120 may comprise a communications server, an application server, and a database server. The communications server, such as a web server, email server, or other such communications server, may communicate with a client facility and an application server. The client facility may include a communications server, database server, application server, file server, or similar facility. The communications server may serve static content. The application server may serve software applications. For instance, the application server may serve knowledge management tools, logistics and collaboration tools, accounting tools, and similar tools. The application server may generate dynamic content. The application server may communicate with the communications server, the database server, the client facility, or some other similar server. The database server may store an enterprise database. The enterprise database may contain information and profiles related to Council Members, Study Groups, Councils, Cohorts, and similar experts, any and all of which may be described herein and elsewhere. The database server may communicate with the application server. The database may be updated by one or more of employers, experts, clients, database owners, or other interested parties. The database server may also store attributes to create a Dynamic Study Group. A Dynamic Study Group may be formed by querying expert attributes stored in a knowledge base or database. For example, a client may request formation of a Dynamic Study Group comprising locally-based neurosurgeons for a survey. A knowledge base or database may be queried for experts who claim an expertise in neurosurgery and are based in a particular location. Attributes stored in a knowledge base or database, such as a knowledge type that is associated with an expert; a type of subject matter on which an expert is willing and/or able to consult; educational level of an expert, and the like, may be derived from responses to taxonomy-based questions, inferences from responses to taxonomy-based questions, profile population and updates by employers, experts, clients, database owners, or other interested parties, a conflict registry, a rules-based input, and the like. Dynamic Study Groups may be saved. Dynamic Study Groups may be automatically or manually updated. The Dynamic Study Group associated with the saved query may be automatically or manually updated as new experts match the necessary criteria or existing Dynamic Study Group members' profile characteristics change. For example and without limitation, for a Dynamic Study Group of cardiologists based in Europe, a new expert with a specialty in cardiology and a listed geography of France would automatically be added and a member who moves from Germany to Mexico would automatically be removed. Dynamic Study Groups may be searchable. Dynamic Study Groups may be searched by the criteria used to generate the Study Group, as well as any associated keywords, comments, or attributes. Keywords, comments, or attributes may be automatically or manually associated with the Dynamic Study Group. For example and without limitation, a Dynamic Study Group of Cardiologists in Europe may be searched using a specialty criterion such as “cardiology”, a geographic criterion such as “Europe”, or a keyword manually or automatically associated with the Dynamic Study Group, such as “stent” or “France.” Without limitation, Dynamic Study Groups may be used in a process for searching and discovering relevant populations within a database; quickly determining how many experts or other respondents are available with common characteristics; easily building new Dynamic Study Groups lists or sub-groups by using a Dynamic Study Group as a base of characteristics and modifying or adding additional criteria; determining appropriate hourly rates by comparing similar experts or other respondents, as well as appropriate referral bounties; navigating from one expert to another with similar characteristics; assessing demand for particular types of experts or other respondents by analyzing most frequently requested or utilized populations; displaying experts and other respondents to their peers for purposes of networking or collaborative projects, and the like.

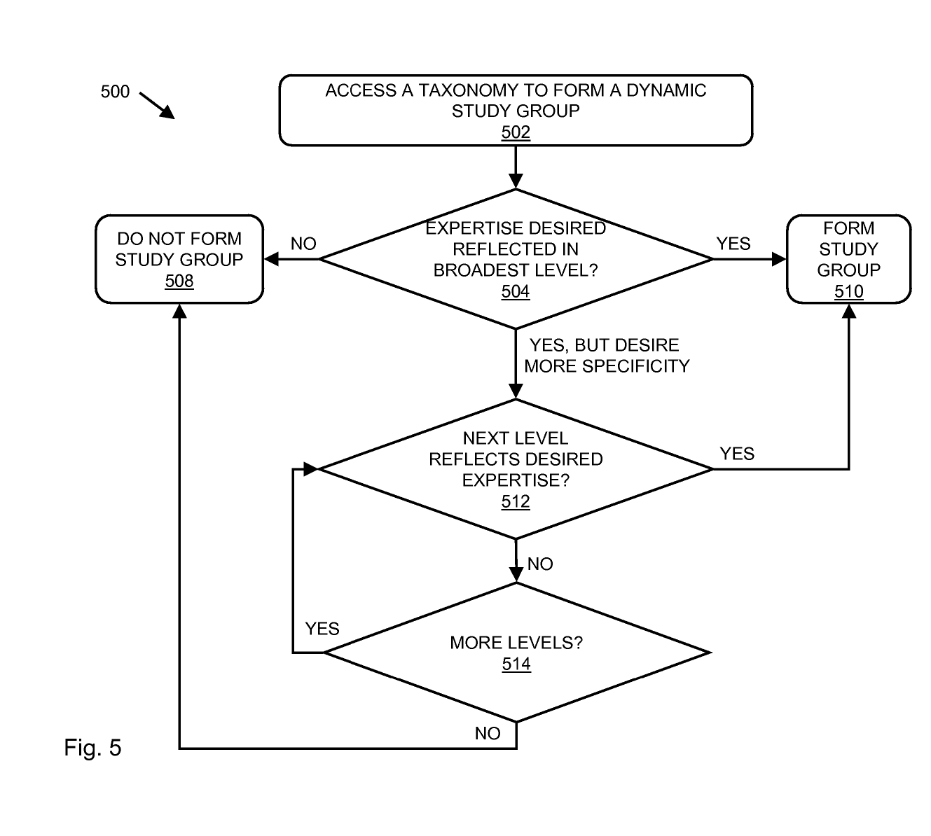

Referring now to FIG. 5, a process 500 of forming a dynamic Study Group may be based upon a position in a taxonomy. For example and without limitation, an expert taxonomy may be accessed to form a dynamic Study Group 502. An expert taxonomy may involve multiple levels wherein each level may be related to a depth of expertise, a specialty, a sub-specialty, and the like. For example and without limitation, the top level of a taxonomy may be medicine. The next levels of the taxonomy may relate to specialties within medicine, such as neurology, cardiology, oncology, and the like. There may be sub-specialties related to each specialty within the taxonomy. For example and without limitation, the next levels below neurology in a taxonomy may be neuropharmacology, neuroendocrinology, neurosurgery, and the like. In the example above, the client's request for forming a Study Group comprised of locally based neurosurgeons may be met by drawing Study Group members from the neurosurgery position in a taxonomy similar to the taxonomy described above. For example and without limitation, if the expertise desired is not reflected in the broadest level of a taxonomy, then experts may not be drawn from that taxonomy to form a Study Group, as may be indicated by logical block 508. If the expertise desired is reflected in the broadest level of a taxonomy, a Study Group may be drawn from experts within the taxonomy, as may be indicated by logical block 510. If the expertise desired is reflected in the broadest level of a taxonomy but a greater specificity of expertise is desired, then the next level of the taxonomy may be accessed, as may be indicated by logical block 512. If the expertise desired is not reflected in the subsequently accessed level of the taxonomy, the process may proceed iteratively through additional levels of the taxonomy with greater specificity, as may be indicated by the test at logical block 514 and the process flow from logical block 514 to logical block 512. If the test at logical block 514 determines that there are no further levels of the taxonomy, then experts may not be drawn from that taxonomy to form a Study Group and processing flow may continue to logical block 508. However, if the test at logical block 514 determines that there are additional levels in the taxonomy, processing flow may return to logical block 512, where the next level in the taxonomy may be accessed and an assessment may be made as to whether the expertise desired is reflected in the currently accessed level of the taxonomy. The process may proceed iteratively until there are no additional levels of the taxonomy or the expertise desired is reflected in the currently accessed level. The expert taxonomy may be linked to, associated with, and/or may feed into a geographic taxonomy, which may facilitate identification of locally-based neurosurgeons or whatever kind of expert may be appropriate in a given circumstance. Many such experts and circumstances will be appreciated and all such experts and circumstances are within the scope of the present disclosure.

Dynamic study groups may additionally or alternatively be formed or modified in response to, in accordance with, and/or in association with client feedback or demand. For example and without limitation, a dynamic study group may be formed by the process shown in FIG. 5. However, a client may give feedback relating to the dynamic study group and/or may modify the membership of the dynamic study group formed by the process shown in FIG. 5. In another example, a client may indicate, such and without limitation by a demand or a suggestion, that a particular expert or group of experts be included in a dynamic study group. For example and without limitation, a client may request that a dynamic study group be formed from experts with whom they are familiar or have once worked. In another example, a client may impose a prioritization on a dynamic study group. For example and without limitation, a client may request that a dynamic study group be formed by the process shown in FIG. 5, but the client may prioritize obtaining experts from a particular geography over others. Clients may give feedback relating to dynamic study groups formed by any method. Clients may modify dynamic study groups formed by any method.

Dynamic study groups may also be formed or modified by expert or Council Member suggestion. For example and without limitation, a dynamic study group may be formed by the process shown in FIG. 5. However, an expert may give feedback relating to the dynamic study group and/or may modify the membership of the dynamic study group formed by the process shown in FIG. 5. In another example, an expert may demand, impose, suggest, et cetera a prioritization of a particular expert or group of experts for a dynamic study group. For example and without limitation, an expert may request that a dynamic study group be formed from experts with whom they are familiar or have once worked. Experts may give feedback relating to dynamic study groups formed by any method. Experts may modify dynamic study groups formed by any method.

It will be appreciated that a dynamic study group may be formed automatically, based upon feedback from a client, based upon an expert's suggestion, based upon a taxonomy, based upon any and all combinations of the foregoing, and so on. The present invention, although described in terms of exemplary embodiments, is not limited to these embodiments. In particular, all methods of forming a dynamic study group, whether described or appreciated from the present disclosure, are within the scope of the present disclosure.

In an embodiment, clients may wish to interact with experts for more in-depth, in-person or ongoing consulting work. In order to identify experts for such work, systems and methods may be used to identify and rank qualified or eligible experts. Ranking experts by certain signals and measures may be helpful in identifying experts who are excellent consultants. For example, an expert cardiologist may be a leader in her field, but because clients have not accessed her repeatedly for consulting work, she may not rank highly among other experts.

In an embodiment, a method for identifying and ranking experts may involve receiving a signal; calculating a rank based upon the signal; and associating the rank with an individual, wherein the rank may provide a measure of the individual's value to a community of clients. Experts may be identified and ranked using an algorithm. The algorithm may be an unbiased, automated system that may be driven by experts. The system may automatically rank experts according to certain criteria, or signals. Alternatively, clients may request that experts be identified and ranked according to certain signals. In embodiments, calculating may involve use of a heuristic, an algorithm, and the like. In embodiments, the signals may be repeat utilization of a particular expert by a client or many clients, an increase in utilization of an expert by a client or many clients, and the like. The algorithm may access a knowledge base 312 in order to identify those experts having had engagements, and who are thus eligible for ranking. Experts may opt out of being accessed for ranking. A group of experts may be identified by at least one of a particular expertise, a geographic region, a gender, an age, a language spoken, a conflict or lack thereof, and the like. For example, sample expert groups for ranking may be attorneys from Boston, female obstetricians, Spanish-speaking environmental engineers, and the like. Once the target group of experts has been identified, they may be accessed for ranking.

In embodiments, experts may be ranked by an indicator based on a frequency of engagement of the expert. In embodiments, experts may be ranked by an indicator based on an increasing frequency of engagement of an individual. In an alternative embodiment, an individual may be ranked by one or more indicators based on repeat engagement of an individual by a single user, repeat engagement of an individual by non-correlated users, a frequency of engagement of an individual, a frequency of engagement of an individual by a single user, a frequency of engagement of an individual by non-correlated users, an increasing frequency of engagement of an individual, an increasing frequency of engagement of an individual by a single user, an increasing frequency of engagement of an individual by non-correlated users, a number of non-correlated users engaging an individual, a number of users engaging an individual, a number of repeat users engaging an individual, a number of articles published, a journal where an article is published, a citation to an article, a speaking engagement, a number of speaking engagements, an aspect of a speaking engagement, a conference attendance, an advisory board membership, an aspect of an advisory board membership, a position at a company, an award, a prestige of an award, a number of grants, a value of grants, an educational level, an educational institution attended, a level of education, a credential, a number of previous engagements, a number of previous engagements for an individual client, a number of clients per time period, a number of current engagements, a feedback rating, an amount earned, a demand for an expert, a supply, a referral to the expert network, a screening of projects for suitability and potential conflicts, an abiding by the terms and conditions for experts, a profile update, a participation in events, an availability, a publication rate, a citation rate, a current academic status, a current employment status, a number of invited lectures, other qualitative and quantitative measures, and the like. For example, an aspect of a speaking engagement may be one or more of a size of the audience, publicity associated with the engagement, a web notice, a number of references, and the like. For example, an aspect of an advisory board membership may be one or more of the market cap of company, the market share of the company, the company's rank in the Fortune 500, and the like. For example, an aspect of publishing may be one or more of publicity, a web notice, a number of references, and the like.

For example, Expert A may be engaged 5 times by the same user and may be ranked higher than Expert B engaged one time each by 5 clients. Even though each expert has been engaged five times in total, Expert A, with repeat engagement by a client, may be more highly ranked because repeat engagement may be an indication of quality of an expert-client interaction. In this example, Expert A may receive one indicator for ranking for the one repeat user while Expert B may receive no indicators because there were no repeat users. In another example, Expert C may be accessed 5 times by one user and 3 times by another user. Expert C may rank higher than Expert D who was engaged one time each by 10 clients. Even though Expert D has been engaged more frequently than Expert C, the expert with repeat engagement, Expert C, by a client may be more highly ranked because repeat engagement may be an indication of quality of an interaction. In this example, Expert C may receive two indicators because Expert C had two repeat users whereas Expert D may receive no indicators for ranking because there were no repeat users.

In another example, Expert E may be engaged once in January, then engaged 4 times in February, then 7 times in March. In contrast, Expert F was engaged 4 times in each of January, February, and March. Expert E may receive a higher ranking than Expert F because Expert E has experienced an increase in frequency of engagement over an identified period of time.

In embodiments, the indicators may be weighted prior to ranking. For example, if a ranking may be of indicators based on a frequency of engagement of an individual and a number of articles published, the indicators may be weighted such that frequency of engagement is more heavily weighted than number of articles published in the final ranking. Weighting the indicators may involve assigning each indicator a score, such as a numeric score, a letter score, a number of stars, and the like. In another example, a frequency of engagement may be weighted by the number of non-correlated users of that expert. In embodiments, ranking an expert may use data from third-party rating systems, such as citation indices.

In an embodiment, the indicator may be an indication of a value of an interaction between the individual and a client in the community. The indication may be an implicit indication.

In an embodiment, the indicator may be a nomination. For example, a ranking of experts based on a frequency of engagement may not include a particular expert who may have had excellent interactions with clients, but may not have been engaged frequently due to extenuating circumstances during the time period of the ranking that prevented him from taking on consulting opportunities. In this example, a client or interested third party may nominate an expert to a higher ranking. In an alternative embodiment, a client or interested third party may nominate an expert to a lower ranking.

In an embodiment, a ranking may be automatically modified based on a change in at least one indicator. For example, ranking an expert may be affected by an expert's screening of projects for suitability and conflicts, or the like. In other examples, ranking may be affected by whether or not an expert has abided by the expert terms and conditions such as conflict management, maintained an updated profile, made efforts to participate in events, taken advantage of and been responsive to opportunities for which they are qualified, stayed up to date on key issues in their field, provided the best information they can and been as helpful as possible to clients, and the like. For example, accepting projects on topics an expert may not be qualified for or where an expert cannot be helpful to clients given potential conflicts and the bounds of any obligations and agreements experts may have to third parties may negatively impact an expert's ranking.

In embodiments, engagement of an expert may include an inconvenience. An inconvenience may be one or more of a time difference, a non-responsiveness, a location, a cost, and the like.

In an embodiment, the expert may be highlighted in a communication depending upon the rank. For example, an article on mutual funds in a client communication may contain quotes from a financial advisor ranking in the top 2% of all financial advisors based on a frequency of engagement. The contact information for the financial advisor may be given in the article. In an embodiment, the expert may be identified to a client depending upon the rank. For example, a client searching for a highly ranked human resource specialist may request to be shown only the top 10% of all human resources experts. In the display of the experts, individual experts may have a status flag next to their names such as “Top 10%”, “Top 5%”, “Top 1%”, “Top 5% Northeast”, and the like. The status flags my also be visible in an expert profile. In an embodiment, the expert may receive a reward as a function of the rank. For example, as a reward, an expert may receive continued eligibility for certain programs and events, such as On-Call projects, My Clients and Events, Visits and Education to maximize engagement potential, ability to pursue ongoing consultative relationships with clients instead of being limited in number, an expanded business network through networking events, access to industry research through education seminars, newsletters, forums, peer-to-peer consultations, and the like, no cap on potential compensation, marketing to clients, a monetary reward, a valuable good, and the like.

In embodiments, the algorithm may weigh the quality of interactions with clients more heavily than volume in ranking. For example, the algorithm may identify the top 20% of all experts based on whether they have been engaged repeatedly and increasingly, over time, by the same or different clients. In another example, the algorithm may rank experts whose frequency of engagements has increased steadily over a given period of time. Once an expert has been identified by the ranking algorithm, top ranked experts may become eligible to engage in in-depth, in-person or ongoing consulting work, privileges, offerings, and the like. In an embodiment, experts may be required to obtain consent from an employer or interested third party, or provide self-consent if they are independent in order to confirm their eligibility.

In an embodiment, a ranked expert may be designated a status as a function of the rank. The status may depend upon the rank in relation to other ranks that are associated with other individuals. For example, a ranking may qualify an expert for membership in a particular group of experts, also known as a qualification group. For example, experts in the top 20% of experts based on ranking by an algorithm may be designated for a second tier qualification group, such as Scholars. In another example, experts in the highest 5% of rankings may be designated for a top tier qualification group, such as Leaders. Membership in a qualification group may provide experts with certain privileges, such as access to certain clients, other experts, event programs, and the like. Certain privileges may be contingent upon exclusivity to the expert referral system 100 network. Membership in a qualification group may enable an expert to participate in as many projects as they would like without restriction as to number. Membership in a qualification group may need to be maintained. For example, once an expert has qualified for a qualification group, continued qualification may require that experts remain responsive to invitations and accept a portion of the projects for which there exists no conflict of interest. Only those projects that pose no conflict of interest and are reasonably within the expert's scope of expertise may be included in the calculation of the rate of project acceptance by an expert. The acceptance target rate may be calculated based on a percentage of an expert's typical project invitation volume, thus assuring that the expert does not have to work more than in the past. Experts who are not qualified by the ranking system may be limited in the number of projects they may participate in for a given time period, the number of clients they may engage with, the scope of any individual project, a combination of any of the above, or the like.

In an embodiment, membership in a qualification group may oblige an individual to exclusivity. For example, experts in certain qualification groups may not engage in phone consultations, surveys, in-person meetings, events, talks, one-on-one meeting, or other speaking engagements with institutional investors outside of the expert referral system 100. For example, qualified experts may consult with corporations and pharmaceutical companies who were not introduced to the expert within the expert referral system 100 and speak at conferences arranged by industry associations. Qualified experts may engage in consulting of a different nature (i.e., long-term projects, due diligence, written reports, etc.) with any type of company.

In an embodiment, experts who do not qualify for a qualification group may still be able to participate in more in-depth, in-person or ongoing consulting work. For example, clients may nominate an expert for qualification to a qualification group if they want to engage the expert in in-depth, in-person or ongoing consulting work. In another example, certain experts may self-nominate for participation in a qualification group. Nominees may include any independent expert or an expert who has her company's consent to participate in more extensive projects or experts who are at the most senior levels of their organization. Nomination to a qualification group may enable an expert to enjoy all of the privileges and requirements of that qualification group. Alternatively, only certain privileges and/or requirements may be applicable to nominees while the remainder may be limited to members qualified by ranking only. Nominated experts may qualify for a nominee qualification group, such as Educators.

In an embodiment, experts may proactively improve their ranking. Experts may improve their ranking by at least one of updating their professional profile with pertinent information, by taking advantage of and being responsive to opportunities for which they are qualified, by staying up to date on key issues in their field, by providing the best information they can and being as helpful as possible to clients, by following the Terms and Conditions of participation as an expert, and the like.

In an embodiment, a ranking may enable experts to receive certain benefits associated with that ranking. In an alternative embodiment, an expert may receive benefits associated with membership in a qualification group. For example, experts may receive status and recognition through expert status flags displayed to clients and staff and in the expert profile. In another example, experts may enjoy continued eligibility for certain programs and events, such as On-Call projects, My Clients and Events, Visits and Education to maximize engagement potential, and the like. In another example, experts may participate in ongoing consultative relationships with clients instead of being limited in number. In another example, experts may enjoy an expanded business network through networking events. In another example, experts may receive access to industry research through education seminars, newsletters, forums, peer-to-peer consultations, and the like. In another example, experts may have no cap on potential compensation. In another example, experts may receive marketing to clients. Not all benefits may be applicable to all rankings or qualification groups.

In an embodiment, experts may opt out of the ranking system. Experts who opt out of the ranking system may be limited in the number of projects they may participate in for a given time period, the number of clients they may engage with, the scope of any individual project, a combination of any of the above, or the like. Also, they may not be promoted to or recognized by clients as a qualified expert, such as Scholar, Leader, or Educator.

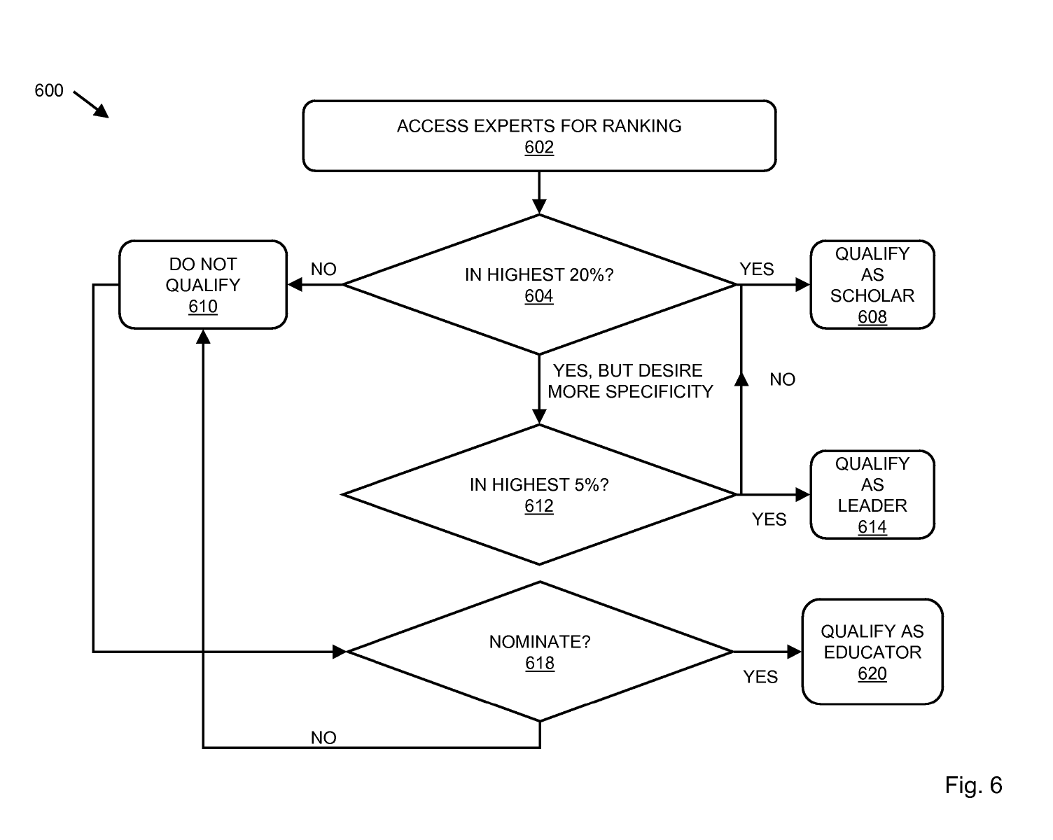

Referring now to FIG. 6, a process 600 for expert ranking may form tiers of qualification groups. For example and without limitation, experts may be accessed for ranking 602. The test in logical block 604 may determine if an expert ranks in the top 20% of experts accessed. If an expert is in the top 20% based on a particular indicator, they may qualify as a Scholar, as may be indicated by logical block 608. If the expert is not in the top 20%, they may not qualify for membership in a qualification group, as may be indicated by logical block 610. For experts in the top 20%, the process may proceed iteratively through additional levels of the ranking process to determine if the expert qualifies for the next highest level of qualification, as may be indicated by the test at logical block 612. If the test at logical block 612 determines that the expert is in the top 5% based on the indicator, they may qualify for the Leader group as may be indicated by logical block 614. If the test at logical block 612 determines that the expert is not in the top 5%, they may still qualify for the Scholar group as may be indicated by logical block 608. For experts who do not qualify based on ranking, they may be nominated by themselves or a third party, as may be indicated by logical block 618. If the expert may be nominated, they may qualify for the Educator group as may be indicated by logical block 620. Many such experts and circumstances will be appreciated and all such experts and circumstances are within the scope of the present disclosure.

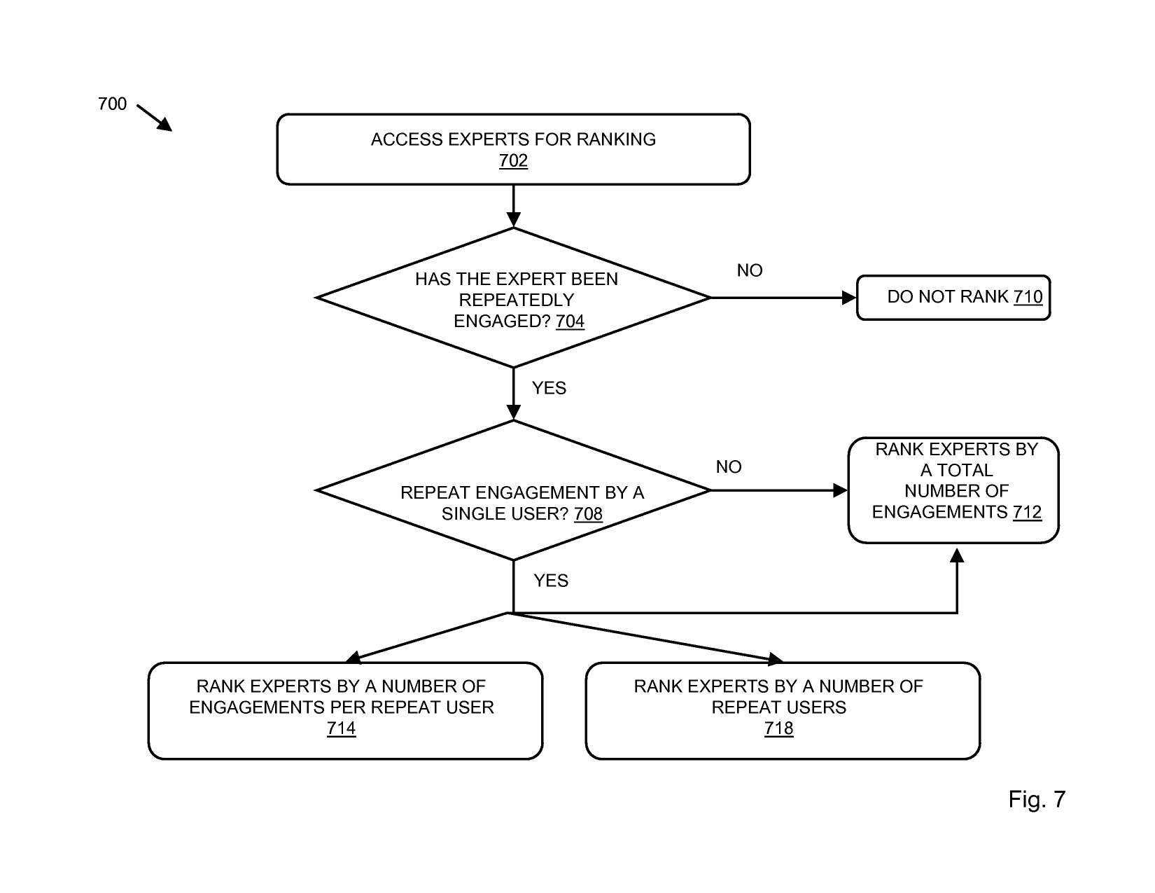

Referring now to FIG. 7, a process 700 for ranking experts may rank experts by repeat engagement. For example and without limitation, experts may be accessed for ranking 702. The test in logical block 704 may determine if an expert has been repeatedly engaged. If an expert has not been repeatedly engaged, they may not be ranked, as may be indicated by logical block 710. If the expert has been repeatedly engaged, process flow may proceed to the test in logical block 708, which may determine if the repeat engagement is by a single user 708. If the repeat engagement is not by a single user, the expert may be ranked by a total number of engagements, as indicated by logical block 712. If the repeat engagement is by a single user, the expert may be ranked by either a number of engagements per repeat user as indicated in logical block 714, a number of repeat users as indicated in logical block 718, or a total number of engagements as indicated by logical block 712.

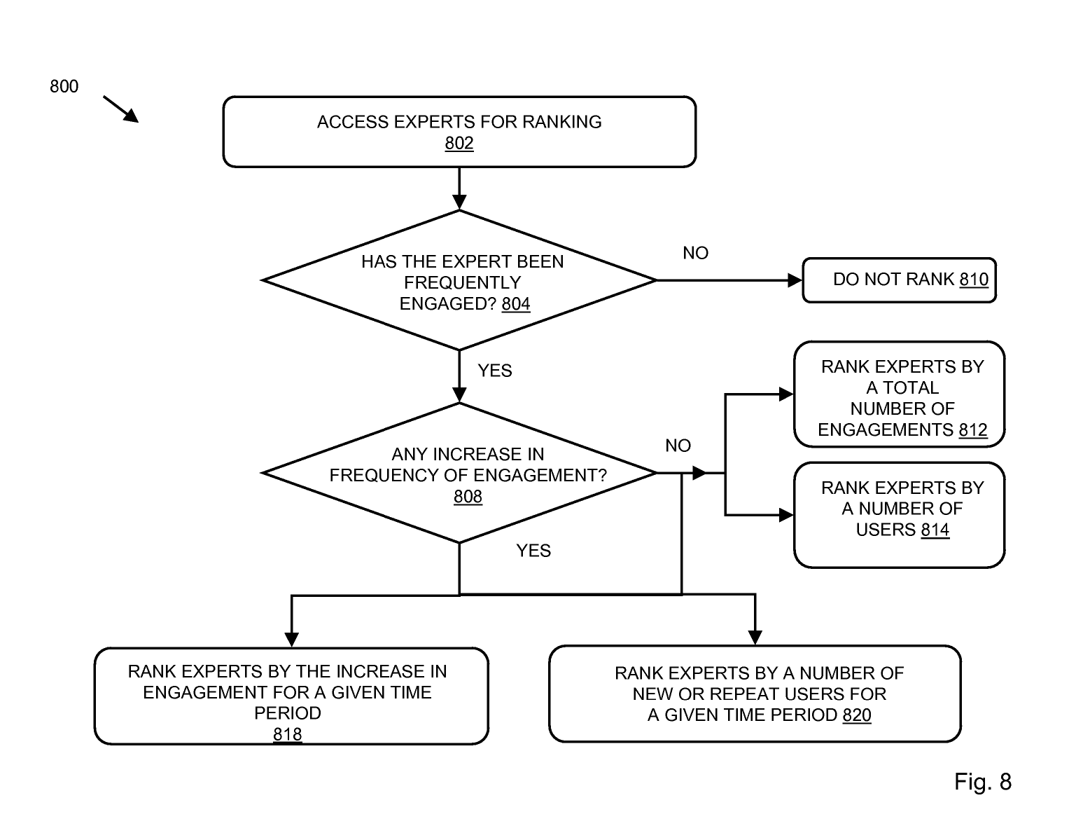

Referring now to FIG. 8, a process 800 for ranking experts may rank experts by a frequency of engagement. For example and without limitation, experts may be accessed for ranking 802. The test in logical block 804 may determine if an expert has been frequently engaged. If an expert has not been frequently engaged, they may not be ranked, as may be indicated by logical block 810. If the expert has been frequently engaged, process flow may proceed to the test in logical block 808, which may determine if the frequency of engagement has been increasing, over a given time period 808. If the frequency of engagement has not been increasing, the expert may be ranked by a total number of engagements as indicated by logical block 812, or a number of users as indicated by logical block 814. If there has been an increase in frequency of engagement over a given time period, ranking may still proceed as if there had not been an increase in frequency. However, ranking may also be by the increase in frequency of engagement for a given time period as indicated in logical block 818, or a number of new or repeat users for a given time period as indicated by logical block 820.

In an embodiment, a method for identifying and ranking content may involve receiving an indicator; calculating a rank based upon the indicator; and associating the rank with the content, wherein the rank may provide a measure of the content's value to a community of content users. In an embodiment, content may be research, articles, transcripts, books, dissertations, treatises, white papers, business-to-business, and the like. In an embodiment, the signal may be determined based on a frequency of citation, an increase in the frequency of citation, the impact factor of the journal, a number of downloads, a number of purchases, a number of times borrowed, a profit earned, and the like. For example, a researcher searching for the best review paper on angiogenesis may access a ranking of angiogenesis review papers to see which papers were in the Top 5 with respect to number of citations.

It will be appreciated that the various steps identified and described above may be varied, and that the order of steps may be changed to suit particular applications of the techniques disclosed herein. All such variations and modifications may be intended to fall within the scope of this disclosure. As such, the depiction and/or description of an order for various steps should not be understood to require a particular order of execution for those steps, unless required by a particular application, or explicitly stated or otherwise be clear from the context.

It will be appreciated that the above processes, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device that may be configured to process electronic signals. It may further be appreciated that the process may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

It may also be appreciated that means for performing the steps associated with the processes described above may include any of the hardware and/or software described above. In another aspect, each process, including individual process steps described above and combinations thereof, may be embodied in computer executable code that, when executing on one or more computing devices, performs the steps thereof.

While the invention has been disclosed in connection with certain preferred embodiments, those of ordinary skill in the art may recognize other embodiments, and all such variations, modifications, and substitutions may be intended to fall within the scope of this disclosure. Thus, the invention may be to be understood in the broadest sense allowable by law.

All documents referenced herein are incorporated by reference.

What is claimed is:

1. A method comprising:
receiving an indicator related to an activity of an individual on behalf of at least one client;
calculating a rank based upon the indicator; and
associating the rank with the individual, wherein the rank provides a measure of the individual's value to a community of clients and wherein the indicator is based on the extent to which the individual has been engaged repeatedly.

2. The method of claim 1, wherein the indicator is based on the frequency of repeat engagement.

3. The method of claim 2, wherein engagement is by the same user.

4. The method of claim 2, wherein engagement is by multiple, non-correlated users.

5. The method of claim 1, wherein ranking is adjusted based on an indicator of an inconvenience.

6. The method of claim 5, wherein the inconvenience is at least one of a time difference, a non-responsiveness, a location, and a cost.

7. The method of claim 1, wherein the indicator is based on a frequency of engagement of an individual.

8. The method of claim 7, wherein engagement is by the same user.

9. The method of claim 7, wherein engagement is by multiple, non-correlated users.

10. The method of claim 1, further comprising adjusting the ranking based on an aspect of a speaking engagement.

11. The method of claim 10, wherein the aspect is one or more of a size of the audience, publicity associated with the engagement, a web notice, and a number of references.

12. The method of claim 1, further comprising adjusting the ranking based on an aspect of publishing.

13. The method of claim 12, wherein the aspect is at least one of publicity, a web notice, and a number of references.

14. The method of claim 1, further comprising adjusting the ranking based on a credential.

15. The method of claim 1, further comprising adjusting the ranking based on an aspect of an advisory board membership.

16. The method of claim 15, wherein the aspect is at least one of the market cap of company, the market share of the company, and the company's rank in the Fortune 500.

17. The method of claim 1, wherein the indicator is an indication of a value of an interaction between the individual and a client in the community.

18. The method of claim 17, wherein the indication is an implicit indication.

19. The method of claim 1, further comprising adjusting the ranking based on a nomination.

20. The method of claim 1, wherein calculating involves the use of a heuristic.

21. The method of claim 1, further comprising designating a status to the individual as a function of the rank.

22. The method of claim 21, wherein the status depends upon the rank in relation to other ranks that are associated with other individuals.

23. The method of claim 1, further comprising highlighting the individual in a communication depending upon the rank.

24. The method of claim 1, further comprising identifying the individual to a client depending upon the rank.

25. The method of claim 1, further comprising providing a reward to the individual as a function of the rank.

26. The method of claim 1, wherein calculating involves weighting at least two indicators to determine the ranking.

27. The method of claim 26, wherein weighting involves assigning a score to an indicator.

28. The method of claim 26, wherein the indicator is at least one of repeat engagement of an individual by a single user, repeat engagement of an individual by non-correlated users, a frequency of engagement of an individual, a frequency of engagement of an individual by a single user, a frequency of engagement of an individual by non-correlated users, an increasing frequency of engagement of an individual, an increasing frequency of engagement of an individual by a single user, an increasing frequency of engagement of an individual by non-correlated users, a number of non-correlated users engaging an individual, a number of users engaging an individual, a number of repeat users engaging an individual, a number of articles published, a journal where an article is published, a citation to an article, a speaking engagement, a number of speaking engagements, an aspect of a speaking engagement, a conference attendance, an advisory board membership, an aspect of an advisory board membership, a position at a company, an award, a prestige of an award, a number of grants, a value of grants, an educational level, an educational institution attended, a level of education, a credential, a number of previous engagements, a number of previous engagements for an individual client, a number of clients per time period, a number of current engagements, a feedback rating, an amount earned, a demand for an expert, a supply, a referral to the expert network, a screening of projects for suitability and potential conflicts, an abiding by the terms and conditions for experts, a profile update, a participation in events, an availability, a publication rate, a citation rate, a current academic status, a current employment status, and a number of invited lectures.

29. The method of claim 1, further comprising automatically modifying a ranking based on a change in at least one indicator.

30. The method of claim 1, wherein an individual can improve their ranking by at least one of updating their professional profile with pertinent information, taking advantage of and being responsive to opportunities for which they are qualified, staying up to date on key issues in their field, providing the best information they can and being as helpful as possible to clients, and by following designated guidelines.

31. The method of claim 1, wherein an individual ranking above a certain threshold qualifies for membership in a qualification group.

32. The method of claim 31, wherein membership in a qualification group is maintained by engaging in a threshold fraction of proposed, non-conflicted engagements per time period.

33. The method of claim 31, wherein membership in a qualification group obliges an individual to exclusivity.

34. The method of claim 31, wherein an individual requires consent to confirm their qualification.

35. The method of claim 31, wherein an individual receives at least one benefit associated with a qualification group.

36. The method of claim 35, wherein the benefit is at least one of status and recognition through status flags displayed in a communication; continued eligibility for certain programs and events; unrestricted consultative relationships with clients; invitations to networking events; access to industry research through education seminars, newsletters, forums, and peer-to-peer consultations; an uncapped potential compensation; and marketing to clients.

37. The method of claim 1, wherein an individual can opt out of being accessed for ranking.

38. The method of claim 1, wherein an individual receives at least one benefit associated with a ranking.

39. The method of claim 38, wherein the benefit is at least one of status and recognition through status flags displayed in a communication; continued eligibility for certain programs and events; unrestricted consultative relationships with clients; invitations to networking events; access to industry research through education seminars, newsletters, forums, and peer-to-peer consultations; an uncapped potential compensation; and marketing to clients.

40. The method of claim 1, wherein the ranking is based on at least two indicia related to engagement of the individual with clients, wherein each of the indicia is assigned a score, wherein the scores are normalized to allow for a ranking based on the normalized scores.

41. The method of claim 40, wherein the indicia are at least one of repeat access of an individual by a single user, repeat access of an individual by non-correlated users, a frequency of access of an individual, a frequency of access of an individual by a single user, a frequency of access of an individual by non-correlated users, an increasing frequency of access of an individual, an increasing frequency of access of an individual by a single user, an increasing frequency of access of an individual by non-correlated users, a number of non-correlated users accessing an individual, a number of users accessing an individual, a number of repeat users accessing an individual, a number of articles published, a journal where an article is published, a citation to an article, a speaking engagement, a number of speaking engagements, an aspect of a speaking engagement, a conference attendance, an advisory board membership, an aspect of an advisory board membership, a position at a company, an award, a prestige of an award, a number of grants, a value of grants, an educational level, an educational institution attended, a level of education, a credential, a number of previous engagements, a number of previous engagements for an individual client, a number of clients per time period, a number of current engagements, a feedback rating, an amount earned, a demand for an expert, a supply, a referral to the expert network, a screening of projects for suitability and potential conflicts, an abiding by the terms and conditions for experts, a profile update, a participation in events, an availability, a publication rate, a citation rate, a current academic status, a current employment status, and a number of invited lectures.
